(19) United States
(12) Patent Application Publication
(10) Pub. No.: US 2023/0196156 A1
(43) Pub. Date: Jun. 22, 2023

(54) HAMILTONIAN DECOMPOSITION USING MID-CIRCUIT OPERATIONS

(71) Applicant: International Business Machines Corporation, Armonk, NY (US)

(72) Inventors: Edward Hong Chen, San Jose, CA (US); Andrew Eddins, Washington, DC (US); Theodore James Yoder, White Plains, NY (US)

(21) Appl. No.: 17/645,480

(22) Filed: Dec. 22, 2021

(51) Int. Cl. G06N 10/20; G06N 10/60

(52) U.S. Cl. CPC G06N 10/20; G06N 10/60

(57) ABSTRACT

Techniques regarding compiling quantum circuits with parallelized entangled measurements are provided. For example, one or more embodiments described herein can comprise a system, which can comprise a memory that can store computer executable components. The system can also comprise a processor, operably coupled to the memory, and that can execute the computer executable components stored in the memory. The computer executable components can comprise a circuit compilation component that can compile one or more quantum circuits for a hybrid quantum-classical algorithm. The one or more quantum circuits can include a mid-circuit operation to parallelize entangled measurements.

### BACKGROUND

The subject disclosure relates to reducing the number of calls to a quantum computer for one or more hybrid quantum-classical algorithms, and more specifically, to utilizing one or more mid-circuit operations, such as mid-circuit measurements and/or measurement resets, to parallelize one or more entangled measurements to execute a hybrid quantum-classical algorithm.

Hybrid quantum-classical algorithms (e.g., variational quantum eigensolver (“VQE”) algorithms) can be employed to calculate the expectation value of a Hamiltonian (e.g., the sum of a product of matrices). Classical computers inherently have limitations regarding the size of the matrix, and thereby the Hamiltonian, that can be analyzed. Quantum computers can be employed to expediate calculations of the sum of product matrices to derive, for example, the ground state of the Hamiltonian. To further expediate the calculations, quantum computers can utilize entangled measurements to determine the value of multiple matrices via a single quantum circuit.

However, for a given quantum computer, the connectivity between qubits can have one or more restrictions. For example, respective Pauli terms can be associated with qubits that are not nearest-neighbors within the hardware circuit of the quantum computer, thereby inhibiting implementation of an entangled measurement. In such situations, conventional means for effectuating the entangled measurement can include the use of multiple SWAP gates. Yet, the addition of SWAP gates can increase operation costs, reduce efficiency, and/or result in an increased likelihood of errors.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatuses and/or computer program products that can compile one or more quantum circuits for one or more hybrid quantum-classical algorithms are described.

According to an embodiment, a system is provided. The system can comprise a system, comprising a memory that can store computer executable components. The system can also comprise a processor, operably coupled to the memory, and that can execute the computer executable components stored in the memory. The computer executable components can comprise a circuit compilation component that can compile one or more quantum circuits for a hybrid quantum-classical algorithm. The one or more quantum circuits can include a mid-circuit operation to parallelize entangled measurements. An advantage of such a system can be the use of entangled measurements with quantum computers having low qubit connectivity.

According to some embodiments, the mid-circuit operation is at least one operation selected from the group of a mid-circuit measurement and a mid-circuit measurement reset. An advantage of such a system can be the use of a mid-circuit measurement reset to implement one or more teleportation operations and/or SWAP gates to enable additional entangled measurements.

According to an embodiment, a computer-implemented method is provided. The computer-implemented method can comprise compiling, by a system operatively coupled to a processor, one or more quantum circuits for a hybrid quantum-classical algorithm. The one or more quantum circuits can include a mid-circuit operation to parallelize entangled measurements. An advantage of such a computer-implemented method can be the application to existing qubit hardware without additional complexity associated with feed-forward or all-to-all qubit connectivity.

According to some embodiments, the computer-implemented method can further comprise executing, by the system, a grouping algorithm to sort Pauli strings into a plurality of groups. Also, the computer-implemented method can comprise assigning, by the system, the entangled measurements to the plurality of groups. An advantage of such a computer-implemented method can be a reduction in the number of calls to a quantum computer when executing one or more hybrid quantum-classical algorithms.

According to another embodiment, a system is provided. The system can comprise a system, comprising a memory that can store computer executable components. The system can also comprise a processor, operably coupled to the memory, and that can execute the computer executable components stored in the memory. The computer executable components can comprise a circuit compilation component that can compile one or more quantum circuits that can include a mid-circuit operation and parallelized entangled measurements based on qubit topology of a quantum computer. An advantage of such a system can be a reduction in amount of calibration needed for quantum computers (e.g., at least because the number of calls to the quantum computer can be reduced).

According to some examples, the system can also comprise an assignment component that can execute a grouping algorithm to sort Pauli strings into a plurality of groups and assign the entangled measurements to the plurality of groups. The system can further comprise a sub-circuit component that can generate a quantum sub-circuit based on a measurement basis of the quantum computer and a qubit connectivity graph that can characterize the qubit topology. An advantage of such a system can be an increase in the number of entangled measurements included in a single quantum circuit.

According to another embodiment, a computer-implemented method is provided. The computer-implemented method can comprise compiling, by a system operatively coupled to a processor, one or more quantum circuits that can include a mid-circuit operation and parallelized entangled measurements based on qubit topology of a quantum computer. An advantage of such a computer-implemented method can be a reduction in the number of quantum circuits required to execute a hybrid quantum-classical algorithm while accounting for one or more hardware constraints of the employed quantum computers.

In some examples, the one or more quantum circuits can be compiled to implement a hybrid quantum-classical algorithm. Also, the mid-circuit operation can be at least one operation selected from the group of a mid-circuit measurement and a mid-circuit measurement reset. An advantage of such a computer-implemented method can be a reduction in the runtime of the hybrid quantum-classical algorithm.

According to an embodiment, a computer program product for compiling quantum circuits is provided. The computer program product can comprise a computer readable storage medium having program instructions embodied therewith. The program instructions can be executable by a processor to cause the processor to compile one or more quantum circuits for a hybrid quantum-classical algorithm. The one or more quantum circuits can include a mid-circuit operation to parallelize entangled measurements. An advantage of such a computer program product can be an increase in the number of entangled measurements that can be performed on a single copy of ansatz wavefunctions.

In some examples, the program instructions further cause the processor to execute a grouping algorithm to sort Pauli strings into a plurality of groups, and assign the entangled measurements to the plurality of groups. Also, the program instructions can cause the processor to generate a quantum sub-circuit based on a measurement basis of a quantum computer executing the hybrid quantum-classical algorithm and a qubit connectivity graph that can characterize a qubit topology of the quantum computer. Further, the program instructions can cause the processor to generate a quantum circuit of the one or more quantum circuits for a group from the plurality of groups based on the measurement basis, the qubit connectivity graph, and an injective map that can characterize a relationship between logical qubits and physical qubits. Moreover, the quantum sub-circuit can be included in the quantum circuit. An advantage of such a computer program product can be a reduction in the computational resources required to execute a hybrid quantum-classical algorithm.

### BRIEF DESCRIPTION OF THE DRAWINGS

FIG. 1 illustrates a block diagram of an example, non-limiting system that can compile one or more quantum circuits that can employ one or more mid-circuit operations to parallelize one or more entangled measurements in accordance with one or more embodiments described herein.

FIG. 2 illustrates a diagram of an example, non-limiting protocol that can be employed to assign one or more Pauli strings to one or more entangled measurements in accordance with one or more embodiments described herein.

FIG. 3 illustrates a block diagram of an example, non-limiting system that can generate one or more quantum sub-circuits that can implement one or more entangled measurements based on qubit connectivity of a quantum computer in accordance with one or more embodiments described herein.

FIG. 4 illustrates a diagram of example, non-limiting quantum sub-circuits that can be generated to implement one or more entangled measurements based on qubit connectivity of a quantum computer in accordance with one or more embodiments described herein.

FIG. 5 illustrates a block diagram of an example, non-limiting system that can compile one or more quantum circuits that can execute one or more hybrid quantum-classical algorithms with minimal calls to one or more quantum computers in accordance with one or more embodiments described herein.

FIG. 6 illustrates a diagram of an example, non-limiting quantum circuit that can be generated to employ mid-circuit quantum operations (e.g., mid-circuit measurements, measurement resets, and/or teleportation) to parallelize entangled measurements in accordance with one or more embodiments described herein.

FIG. 7 illustrates a diagram of an example, non-limiting quantum circuit modification that can be implemented to parallelize entangled measurements and reduce calls to one or more quantum computer in accordance with one or more embodiments described herein.

FIG. 8 illustrates a diagram of an example, non-limiting graph and table that can demonstrate the increased efficiency that can be achieved by one or more quantum circuits compiled in accordance with one or more embodiments described herein.

FIG. 9 illustrates a flow diagram of an example, non-limiting computer-implemented method that can facilitate compiling one or more quantum circuits that can employ one or more mid-circuit operations to parallelize one or more entangled measurements in accordance with one or more embodiments described herein.

FIG. 10 depicts a cloud computing environment in accordance with one or more embodiments described herein.

FIG. 11 depicts abstraction model layers in accordance with one or more embodiments described herein.

FIG. 12 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Given the problems with other implementations of compiling quantum circuits (e.g., the addition of numerous SWAP gates can increase operation costs, reduce efficiency, and/or result in an increased likelihood of errors); the present disclosure can be implemented to produce a solution to one or more of these problems by employing mid-circuit operations to measure entangled states between qubits that are not physically connected directly to each other within the quantum computer hardware. Advantageously, one or more embodiments described herein can reduce the number of calls made to a quantum computer from a classical computer when executing one or more hybrid quantum-classical algorithms. Further, various embodiments described herein can implement entangled measurements between qubits other than nearest-neighboring qubits. Thereby, one or more embodiments described herein can enable one or more hybrid quantum-classical algorithms (e.g., VQE algorithms) to be executed on one or more quantum computers that have reduced qubit connectivity (e.g., quantum computers utilizing superconducting qubits, dots, or photons). For example, various embodiments described herein can implemented parallelized entangled measurements based on the measurement basis and/or qubit topology of the quantum computer that will be executing the one or more quantum circuits.

Various embodiments of the present invention can be directed to computer processing systems, computer-implemented methods, apparatus and/or computer program products that facilitate the efficient, effective, and autonomous (e.g., without direct human guidance) quantum circuit compilation. For example, one or more embodiments described herein can assign entangled measurements to Pauli strings designated for measurement by one or more hybrid quantum-classical algorithms. Further, one or more embodiments described herein can generate one or more quantum sub-circuits based on the measurement basis and/or the qubit connectivity of one or more quantum computers executing the one or more hybrid quantum-classical algorithms. Moreover, various embodiments described herein can employ the one or more quantum sub-circuits to generate one or more quantum circuits that can reduce the number of calls to the quantum computer by utilizing one or more mid-circuit operations (e.g., mid-circuit measurements, measurement resets) to parallelize the entangled measurements (e.g., via one or more teleportation operations and/or SWAP gates).

The computer processing systems, computer-implemented methods, apparatus and/or computer program products employ hardware and/or software to solve problems that are highly technical in nature (e.g., enabling entangled measurements in quantum computers having low qubit connectivity), that are not abstract and cannot be performed as a set of mental acts by a human. For example, an individual, or a plurality of individuals, cannot compile a quantum circuit with mid-circuit operations to implement entangled measurements between distanced qubits of a quantum computer.

Also, one or more embodiments described herein can constitute a technical improvement over conventional generation of quantum circuits for hybrid quantum-classical algorithms by utilizing mid-circuit operations (e.g., mid-circuit measurement and/or measurement reset operations) to increase the number of entangled measurements that can be performed on a single copy of ansatz wavefunctions; thereby enabling the entangled measurements to be applied to existing qubit hardware without the additional complexity necessitated by feed-forward or all-to-all qubit connectivity. Further, one or more embodiments described herein can have a practical application by utilizing parallelized entangled measurements to reduce the number of calls to the quantum computer; thereby reducing the total execution time of the algorithm and improving the accuracy of the computational result (e.g., by reducing drift in the operation and calibration of the quantum computer hardware). One or more embodiments described herein can control the compilation of one or more quantum circuits, which can include parallelized entangled measurements based on the qubit connectivity of one or more quantum computers executing a hybrid quantum-classical algorithm.

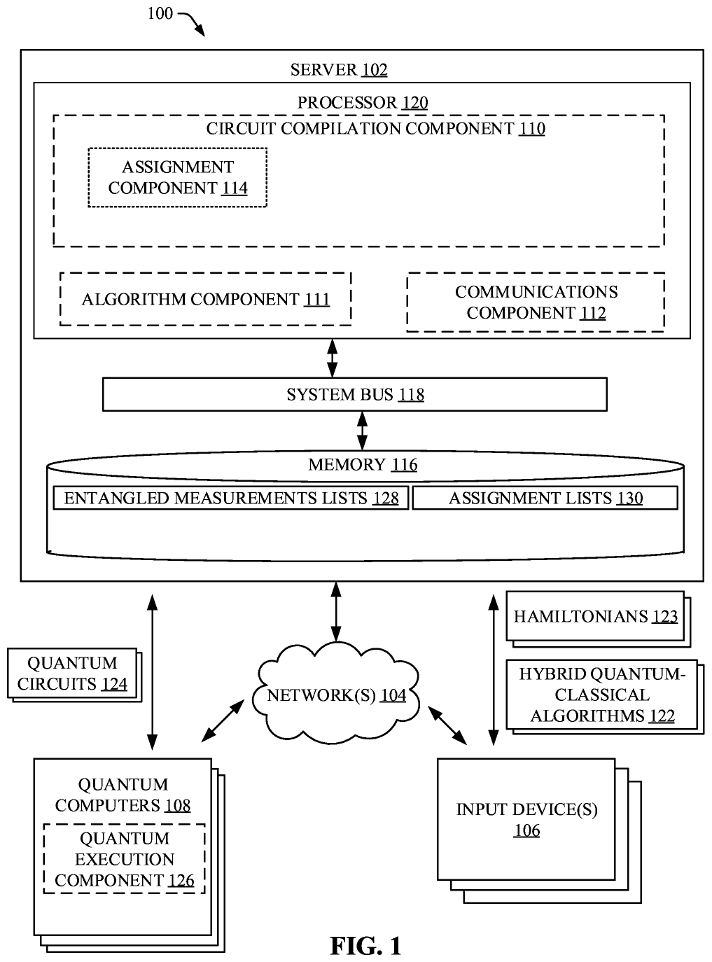

FIG. 1 illustrates a block diagram of an example, non-limiting system 100 that can compile one or more quantum circuits for one or more hybrid quantum-classical algorithms (e.g., one or more VQE algorithms), where the quantum circuits can utilize one or more mid-circuit operations to parallelize multiple entangled measurements. Repetitive description of like elements employed in other embodiments described herein is omitted for the sake of brevity. Aspects of systems (e.g., system 100 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines (e.g., computers, computing devices, virtual machines, a combination thereof, and/or the like) can cause the machines to perform the operations described. In various embodiments, Pauli operators can be denoted by “I”, “X”, “Z”, or “Y” in accordance with their standard meaning quantum mechanics.

As shown in FIG. 1, the system 100 can comprise one or more servers 102, one or more networks 104, input devices 106, and/or quantum computers 108. The server 102 can comprise circuit compilation component 110, algorithm component 111, and/or communications component 112. The circuit compilation component 110 can further comprise assignment component 114. Also, the server 102 can comprise or otherwise be associated with at least one memory 116. The server 102 can further comprise a system bus 118 that can couple to various components such as, but not limited to, the circuit compilation component 110 (e.g., and associated components), the algorithm component 111, the communications component 112, memory 116 and/or a processor 120. While a server 102 is illustrated in FIG. 1, in other embodiments, multiple devices of various types can be associated with or comprise the features shown in FIG. 1. Further, the server 102 can communicate with one or more cloud computing environments.

The one or more networks 104 can comprise wired and wireless networks, including, but not limited to, a cellular network, a wide area network (WAN) (e.g., the Internet) or a local area network (LAN). For example, the server 102 can communicate with the one or more input devices 106 and/or quantum computers 108 (and vice versa) using virtually any desired wired or wireless technology including for example, but not limited to: cellular, WAN, wireless fidelity (Wi-Fi), Wi-Max, WLAN, Bluetooth technology, a combination thereof, and/or the like. Further, although in the embodiment shown the circuit compilation component 110 and/or the algorithm component 111 can be provided on the one or more servers 102, it should be appreciated that the architecture of system 100 is not so limited. For example, the circuit compilation component 110 (e.g., or one or more components of circuit compilation component 110) and/or the algorithm component 111, can be located at another computer device, such as another server device, a client device, and/or the like.

The one or more input devices 106 can comprise one or more computerized devices, which can include, but are not limited to: personal computers, desktop computers, laptop computers, cellular telephones (e.g., smart phones), computerized tablets (e.g., comprising a processor), smart watches, keyboards, touch screens, mice, a combination thereof, and/or the like. The one or more input devices 106 can be employed to enter one or more Hamiltonians 123 and/or hybrid quantum-classical algorithms 122 into the system 100, thereby sharing (e.g., via a direct connection and/or via the one or more networks 104) said data with the server 102. For example, the one or more input devices 106 can send data to the communications component 112 (e.g., via a direct connection and/or via the one or more networks 104). Additionally, the one or more input devices 106 can comprise one or more displays that can present one or more outputs generated by the system 100 to a user. For example, the one or more displays can include, but are not limited to: cathode tube display (“CRT”), light-emitting diode display (“LED”), electroluminescent display (“ELD”), plasma display panel (“PDP”), liquid crystal display (“LCD”), organic light-emitting diode display (“OLED”), a combination thereof, and/or the like.

In various embodiments, the one or more input devices 106 and/or the one or more networks 104 can be employed to input one or more settings and/or commands into the system 100. For example, in the various embodiments described herein, the one or more input devices 106 can be employed to operate and/or manipulate the server 102 and/or associate components. Additionally, the one or more input devices 106 can be employed to display one or more outputs (e.g., displays, data, visualizations, and/or the like) generated by the server 102 and/or associate components. Further, in one or more embodiments, the one or more input devices 106 can be comprised within, and/or operably coupled to, a cloud computing environment.

In one or more embodiments, the one or more input devices 106 can be employed to enter one or more hybrid quantum-classical algorithms 122 into the system 100. The one or more hybrid quantum-classical algorithms 122 can delineate computation routines for a combination of quantum computing hardware and classical computing hardware to execute a defined task. For instance, the one or more hybrid quantum-classical algorithms 122 can delineate quantum state preparation and measurements to be performed by the one or more quantum computers 108, along with optimization and/or analysis techniques to be performed by the algorithm component 111. In various embodiments, the defined task of the one or more hybrid quantum-classical algorithms 122 can be to, for example, determine the ground state eigenvector and/or eigenvalue of a Hermitian operator. Additionally, the one or more input devices 106 can be employed to enter one or more Hamiltonians 123 into the system 100. The one or more Hamiltonians 123 can be analyzed by the one or more hybrid quantum-classical algorithms 122 and/or can define one or more matrices of Pauli strings to be measured.

In one or more embodiments, the circuit compilation component 110 can compile one or more quantum circuits 124 based on the one or more hybrid quantum-classical algorithms 122 and/or Hamiltonians 123 and/or the qubit topology of the one or more quantum computers 108. For example, the circuit compilation component 110 can assign entangled measurements to one or more of the Pauli strings delineated by the one or more Hamiltonians 123. Further, the circuit compilation component 110 can effectuate the entangled measurements by compiling quantum circuits 124 that employ mid-circuit operations (e.g., mid-circuit measurements, measurement resets, and/or teleportation) to implement the one or more hybrid quantum-classical algorithms 122. As used herein, the term “mid-circuit operations” can refer to one or more non-unitary operations (e.g., non-unitary reinitialization operations, and/or non-unitary measurement operations) that can occur between the first initialization and the final measurement of a circuit. Example mid-circuit operations can include min-circuit measurement operations and/or mid-circuit measurement reset operations. The one or more quantum circuits 124 can delineate a computation routine for the one or more quantum computers 108. For example, the one or more quantum circuits 124 can describe one or more coherent quantum operations on quantum data. In various embodiments, the one or more quantum circuits 124 can delineate the number of qubits and/or qubit connectivity employed by the one or more quantum computers 108 to execute one or more hybrid quantum-classical algorithms 122. For instance, the one or more quantum circuits 124 can describe, with regards to one or more qubits: initialization and reset operations (e.g., initialization of one or more qubits to one or more desired states), quantum gates (e.g., Hadamard gates, phase shifter gates, controlled gates, uncontrolled gates, phase rotation gate, controlled-NOT (“CNOT”) gate, single qubit gates, multi-qubit gates, cross-resonance gates, a combination thereof, and/or the like), measurement operations, measurement reset operations, and/or classically controlled quantum gates.

Additionally, the algorithm component 111 can execute the classical computing computations defined by the one or more hybrid quantum-classical algorithms 122 and share the one or more quantum circuits 124 with the one or more quantum computers 108 to perform the quantum computing computations (e.g., via quantum executions component 126).

In various embodiments, the one or more hybrid quantum-classical algorithms 122 can be, for example, one or more VQE algorithms, which can share computational work between classical computing hardware (e.g., the one or more servers 102 via the algorithm component 111) and quantum computing hardware (e.g., the one or more quantum computers 108 via the quantum executions component 126) to reduce the long coherence times required by all-quantum phase estimation algorithms. A VQE algorithm can be initialized with one or more assumptions regarding the form of a target wavefunction. Based on the one or more assumptions, an ansatz with one or more tunable parameters can be constructed and a quantum circuit 124 capable of producing the ansatz can be designed. Throughout execution of the VQE algorithm, the ansatz parameters can be variationally adjusted to minimize the expectation value of resulting Hamiltonian matrix. Classical computing hardware (e.g., the one or more servers 102 via the algorithm component 111) can precompute one or more terms of the Hamiltonian matrix and/or update the parameters during compilation of the one or more quantum circuits 124. The quantum hardware (e.g., the one or more quantum computers 108 via the quantum executions component 126) can prepare a quantum state (e.g., defined by the current iteration's set of ansatz parameter values) and/or perform measurements of various interaction terms in the Hamiltonian matrix. The state preparation can be repeated over multiple iterations until each individual operator has been measured enough times to derive sufficient statistical data. Additionally, the efficiency of VQE algorithms can be improved by using particle-hole mapping of the quantum Hamiltonian to produce improved starting points for the trail wavefunction. Further, methods to reduce the number of qubits required for electronic structure calculations (e.g., such as qubit tapering) can eliminate redundant degrees of freedom in the Hamiltonian.

For example, in various embodiments the one or more input devices 106 can be employed to enter one or more initial quantum Hamiltonians 123 into the system 100 for analysis via one or more VQE algorithms. For example, the initial quantum Hamiltonian 123 can comprise a sum of Pauli matrices and/or can be obtained by applying one or more versions of a Jordan-Wigner encoding. The initial quantum Hamiltonian 123 can characterize the inter-particle interactions of a chemical system, which can be a set of separable, or inseparable, operators that can evolve the wavefunction to a stationary eigenstate (e.g., wherein the eigenvalues of which are the energy). In one or more embodiments, the system 100 can be initialized with the atomic coordinates (e.g., internal or absolute) of one or more given molecules and/or atom types/basis sets, from which the initial quantum Hamiltonian 123 can be derived.

In various embodiments, the one or more quantum computers 108 can comprise quantum hardware devices that can utilize the laws of quantum mechanics (e.g., such as superposition and/or quantum entangled) to facilitate computational processing (e.g., while satisfying the DiVincenzo criteria). In one or more embodiments, the one or more quantum computers 108 can comprise a quantum data plane, a control processor plane, a control and measurement plane, and/or a qubit technology.

In one or more embodiments, the quantum data plane can include one or more quantum circuits comprising physical qubits, structures to secure the positioning of the qubits, and/or support circuitry. The support circuitry can, for example, facilitate measurement of the qubits' state and/or perform gate operations on the qubits (e.g., for a gate-based system). In some embodiments, the support circuitry can comprise a wiring network that can enable multiple qubits to interact with each other. Further, the wiring network can facilitate the transmission of control signals via a direct electrical connection and/or electromagnetic radiation (e.g., optical, microwave, and/or low-frequency signals). For instance, the support circuitry can comprise one or more superconducting resonators operatively coupled to the one or more qubits. As described herein the term “superconducting” can characterize a material that exhibits superconducting properties at or below a superconducting critical temperature, such as aluminum (e.g., superconducting critical temperature of 1.2 Kelvin) or niobium (e.g., superconducting critical temperature of 9.3 Kelvin). Additionally, one of ordinary skill in the art will recognize that other superconductor materials (e.g., hydride superconductors, such as lithium/magnesium hydride alloys) can be used in the various embodiments described herein.

In one or more embodiments, the control processor plane can identify and/or trigger a Hamiltonian sequence of quantum gate operations and/or measurements, wherein the sequence executes a program (e.g., provided by a host processor, such as server 102, via algorithm component 111) for implementing a quantum algorithm (e.g., a portion of a hybrid quantum-classical algorithm). For example, the control processor plane can convert compiled code to commands for the control and measurement plane. In one or more embodiments, the control processor plane can further execute one or more quantum error correction algorithms.

In one or more embodiments, the control and measurement plane can convert digital signals generated by the control processor plane, which can delineate quantum operations to be performed, into analog control signals to perform the operations on the one or more qubits in the quantum data plane. Also, the control and measurement plane can convert one or more analog measurement outputs of the qubits in the data plane to classical binary data that can be shared with other components of the system 100 (e.g., such as the algorithm component 111, via, for example, the control processor plane).

One of ordinary skill in the art will recognize that a variety of qubit technologies can provide the basis for the one or more qubits of the one or more quantum computers 108. Two exemplary qubit technologies can include trapped ion qubits and/or superconducting qubits. For instance, superconducting qubits (e.g., such as superconducting quantum interference devices “SQUIDs”) can be lithographically defined electronic circuits that can be cooled to milli-Kelvin temperatures to exhibit quantized energy levels (e.g., due to quantized states of electronic charge or magnetic flux). Superconducting qubits can be Josephson junction-based, such as transmon qubits and/or the like. Also, superconducting qubits can be compatible with microwave control electronics, and can be utilized with gate-based technology or integrated cryogenic controls. Additional exemplary qubit technologies can include, but are not limited to: photonic qubits, quantum dot qubits, gate-based neutral atom qubits, semiconductor qubits (e.g., optically gated or electrically gated), topological qubits, a combination thereof, and/or the like.

In one or more embodiments, the communications component 112 can receive one or more quantum circuits 124 from the algorithm component 111 and share (e.g., via a direct electrical connection and/or through the one or more networks 104) the one or more quantum circuits 124 with the one or more quantum computers 108 to execute the hybrid quantum-classical algorithm. Additionally, the communications component 112 can facilitate the sharing of computational results data between the quantum executions component 126 and the algorithm component 111 and/or vice versa (e.g., via a direct electrical connection and/or through the one or more networks 104). For example, in various embodiments the circuit compilation component 110 can compile one or more quantum circuits 124, which can be executed by the one or more quantum computers 108 (e.g., via quantum execution component 126) to perform the one or more hybrid quantum-classical algorithms 122. In accordance with one or more embodiments described herein, each quantum circuit 124 can be associated with a respective call to the one or more quantum computers 108, where the quantum computers 108 can execute the quantum circuit 124 to generate result data that can be further processed by the algorithm component 111 (e.g., in accordance with the hybrid quantum-classical algorithm 122) to complete the given task.

In various embodiments, the assignment component 114 can assign entangled measurements to Pauli strings defined by the one or more Hamiltonians 123. For instance, the Pauli strings can be analyzed by the one or more hybrid quantum-classical algorithms 122 and/or the one or more quantum computers 108 in accordance with the one or more quantum circuits 124. The assigned entangled measurements can enable a plurality of the Pauli strings to be implemented on the same call to the quantum computer 108 (e.g., via the same quantum circuit 124). For instance, the assignment component 114 can group Pauli strings with one or more matching characteristics (e.g., such as qubit connectivity). In another instance, the assignment component 114 can group Pauli strings based on similarity, where Pauli strings having a similarity value greater than a defined threshold are grouped together. In one or more embodiments, the size of the groups can depend on the number of qubits, and/or qubit connectivity, of the one or more quantum computers 108. Further, the assignment component 114 can assign one or more entangled measurements to the groups from one or more entangled measurements lists 128. In one or more embodiments, the circuit compilation component 110 can generate a quantum circuit 124 for each group defined by the assignment component 114.

For example, the one or more entangled measurements lists 128 can be stored in the one or more memories 116. The one or more entangled measurements lists 128 can define a plurality of entangled measurements that can be employed to parallelize the Pauli string measurements. In one or more embodiments, the one or more entangled measurements lists 128 can be ordered, for example, from those Pauli strings that are physically closest to those Pauli strings that are physically furthest apart. For instance, given a linear chain of qubits: q0, q1, q2, and/or q3; the entangled measurements (XXII,YYII,ZZII) can be higher on the entangled measurement list 128 than entangled measurements (XXIIX,YYIIY,ZIIZ), where the ordering of the Pauli strings can correspond to the physical placement of the qubits in the linear chain. In another instance, the ordering can be based on one or more lattices of qubits describing qubit connectivity (e.g., hexagonal lattice characterizing qubit connectivity). Example entangled measurements can include, but are not limited to: Bell basis entangled measurements, Omega basis entangled measurements, Entanglion entangled measurements, greater than or equal to two-qubit entangled measurements, Greenberger-Horne-Zeilinger states, W states, a combination thereof, and/or the like. Further, in various embodiments, the assignment component 114 can generate one or more databases, lists, tables, charts, and/or the like delineating the entangled measurement assignments. For example, the assignment component 114 can generate one or more assignment lists 130 (e.g., stored in the one or more memories 116), which can define the one or more assignments performed by the assignment component 114.

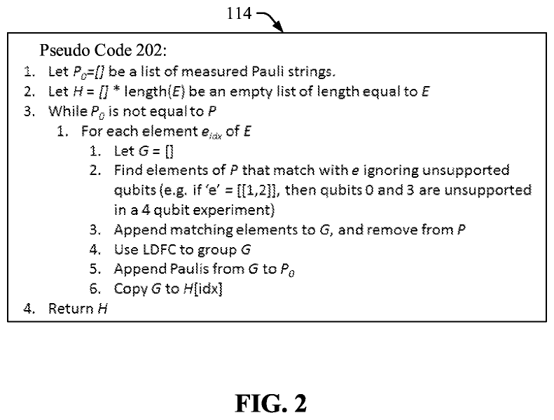

FIG. 2 illustrates a diagram of an example, non-limiting pseudo code 202 that can be implemented by the assignment component 114 in accordance with one or more embodiments described herein. Repetitive description of like elements employed in other embodiments described herein is omitted for the sake of brevity. As shown in FIG. 2, “P” can be a list of Pauli strings, “H” can be the one or more assignment lists 130, “E” can be a list of entangled measurements (e.g., the one or more entangled measurements lists 128), “G” can be the one or more groups generated by the assignment component 114, and/or “e” can be one or more elements of the entangled measurements.

In one or more embodiments, the assignment component 114 can employ one or more heuristic algorithms to facilitate grouping the Pauli strings. For example, example pseudo code 202 employs a largest degree first coloring algorithm (“LDFC”) to facilitate the grouping. However, the architecture of the assignment component 114 is not limited to embodiments employing the LDFC algorithm; other embodiments, employing one or more alternate grouping algorithms (e.g., largest-first algorithms, recursive largest-first algorithms, qubit-wise commuting algorithms, commuting algorithms, anti-commuting algorithms, a combination thereof, and/or the like), are also envisaged. In one or more embodiments, the one or more heuristic algorithms employed by the assignment component 114 can facilitate minimizing the number of groups generated by the assignment component 114 to further reduce the number of calls to the one or more quantum computers 108 (e.g., where each group is associated with a quantum circuit 124, and each quantum circuit 124 is associated with a call to the one or more quantum computers 108). Additionally, minimizing the number of groups can also result in a reduction in the number of entangled measurements required in the one or more quantum circuits 124.

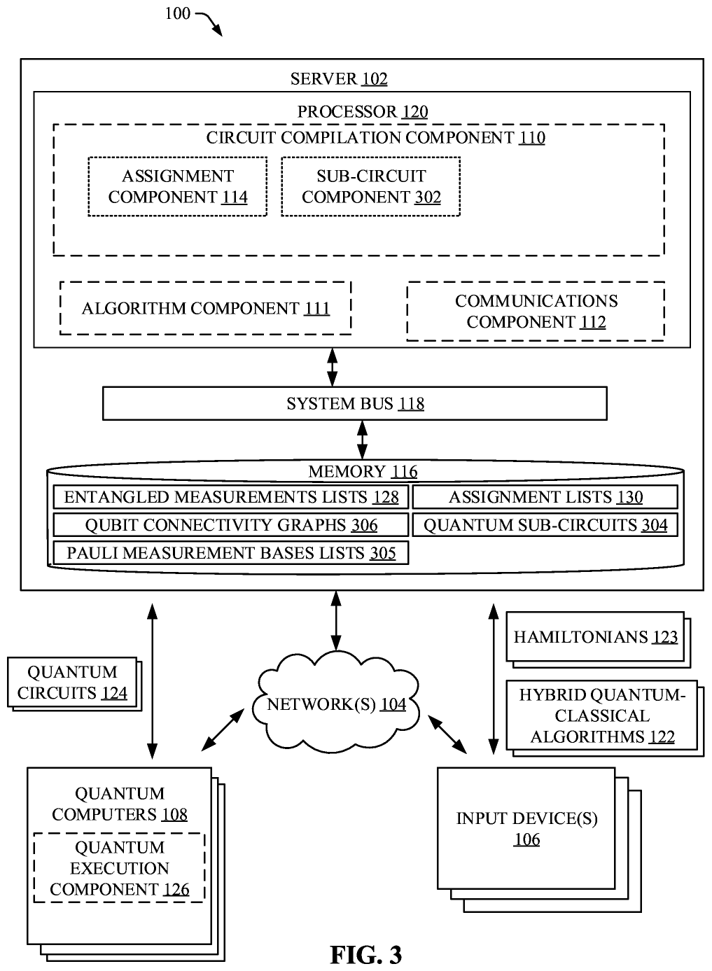

FIG. 3 illustrates a diagram of the example, non-limiting circuit compilation component 110 further comprising sub-circuit component 302 in accordance with one or more embodiments described herein. Repetitive description of like elements employed in other embodiments described herein is omitted for the sake of brevity. In various embodiments, sub-circuit component 302 can generate one or more quantum sub-circuits 304 that can be included in the one or more quantum circuits 124 to effectuate one or more of the entangled measurements. In one or more embodiments, the one or more quantum sub-circuits 304 can be stored in the one or more memories 116, and/or retrieved by one or more associate components of the circuit compilation component 110 (e.g., as shown in FIG. 3).

In one or more embodiments, the qubit connectivity of the one or more quantum computers 108 can be described by one or more qubit connectivity graphs 306. For example, the one or more qubit connectivity graphs 306 can describe the hardware and/or hardware connections of the one or more quantum computers 108. For instance, the one or more qubit connectivity graphs 306 can describe the physical qubits comprised within the one or more quantum computers 108 and/or the qubit connectivity employed by the one or more quantum computers 108. For instance, qubits of the one or more quantum computers 108 can be represented as nodes within the one or more qubit connectivity graphs 306, with lines between nodes representing qubit connections. In various embodiments, the one or more qubit connectivity graphs 306 can be entered into the system 100 via the one or more input devices 106 and/or the quantum computers 108.

Additionally, the one or more input devices 106 and/or quantum computers 108 can be employed to enter one or more Pauli measurement bases lists 305 into the system 100, where the one or more Pauli measurement bases lists 305 can describe one or more measurement bases of the one or more quantum computers 108. For example, the native hardware of the one or more quantum computers 108 can be based on two-qubit gates; thereby the measurement bases for the one or more quantum computers 108 can comprise a single-qubit measurement basis and a two-qubit measurement basis, as described from one or more Pauli measurement bases lists 305 associated with the one or more quantum computers 108. In another example, the native hardware of the one or more quantum computers 108 can be based on quantum gates involving more than two qubits; thereby, the measurement bases for the one or more quantum computers 108 can comprise a single-qubit measurement basis, a two-qubit measurement basis, and one or more additional measurement bases as described from the one or more Pauli measurement bases lists 305.

For each measurement basis involving two or more qubits, the sub-circuit component 302 can generate one or more quantum sub-circuits 304 that can effectuate entangled measurements between qubits based on the one or more qubit connectivity graphs 306. For example, the one or more qubit connectivity graphs 306 can delineate one or more paths (e.g., collection of connecting lines, intermediate nodes, and/or adjacent nodes) between targeted qubits. In accordance with given measurement basis of the one or more quantum computers 108, the sub-circuit component 302 can compile a series of quantum operations into one or more quantum sub-circuits 304, where the series of quantum operations can move one or more targeted qubits of a measurement pair through a targeted path of the one or more qubit connectivity graphs 306. For example, the series of quantum operations can include, but are not limited to: quantum gates (e.g., SWAP gates), quantum teleportation, a measurement operation (e.g., a Bell measurement), stabilizer and recovery operations (e.g., which can preserve entangled quantum states among a set of data qubits), dynamical decoupling operations, algorithmic operations (e.g., phase estimation, Grover's search, and/or the like), a combination thereof, and/or the like.

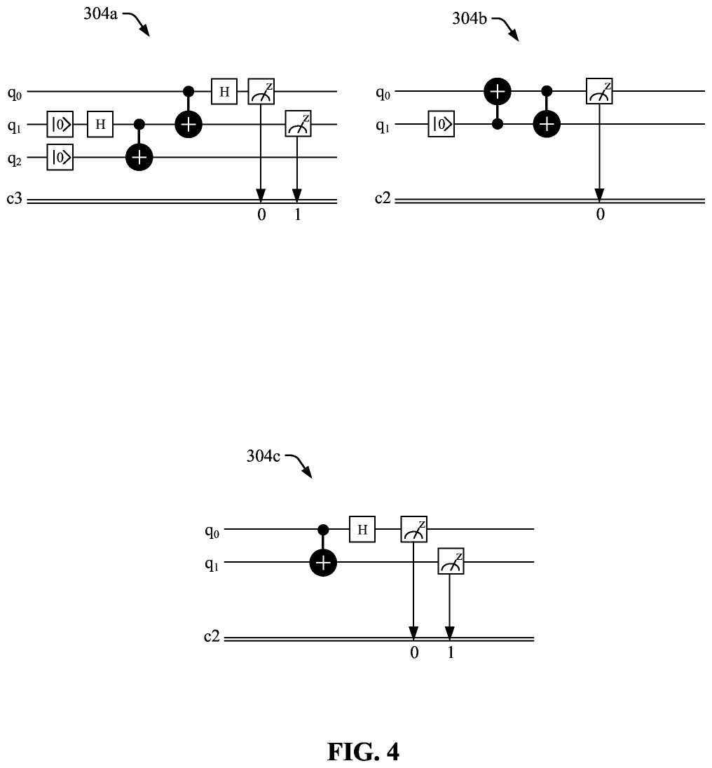

FIG. 4 illustrates a diagram of example, non-limiting quantum sub-circuits 304a, 304b, and/or 304c that can be generated by the sub-circuit component 302 in accordance with one or more embodiments described herein. Repetitive description of like elements employed in other embodiments described herein is omitted for the sake of brevity. FIG. 4 regards an example instance where the one or more quantum computers 108 have a two-qubit measurement basis “m”. For example, m can equal [XX,ZZ]. Additionally, single-qubit measurements can be implemented by inserting an appropriate single-qubit Clifford gate prior to the measurement operation. Where “L” is the length of a target path “P” of the one or more qubit connectivity graphs 304, the sub-circuit component 302 can employ floor(L/2) uses of teleportation (e.g., as shown in the first example quantum sub-circuit 304a) and L %2 uses of single-qubit SWAP gates (e.g., as shown in the second example quantum sub-circuit 304b) to move the first qubit of the measurement pair along the target path P. Further, the sub-circuit component 302 can apply a Bell measurement circuit (e.g., as shown in the third example quantum sub-circuit 304c) in the last qubit in the path P and the second qubit of the measurement pair.

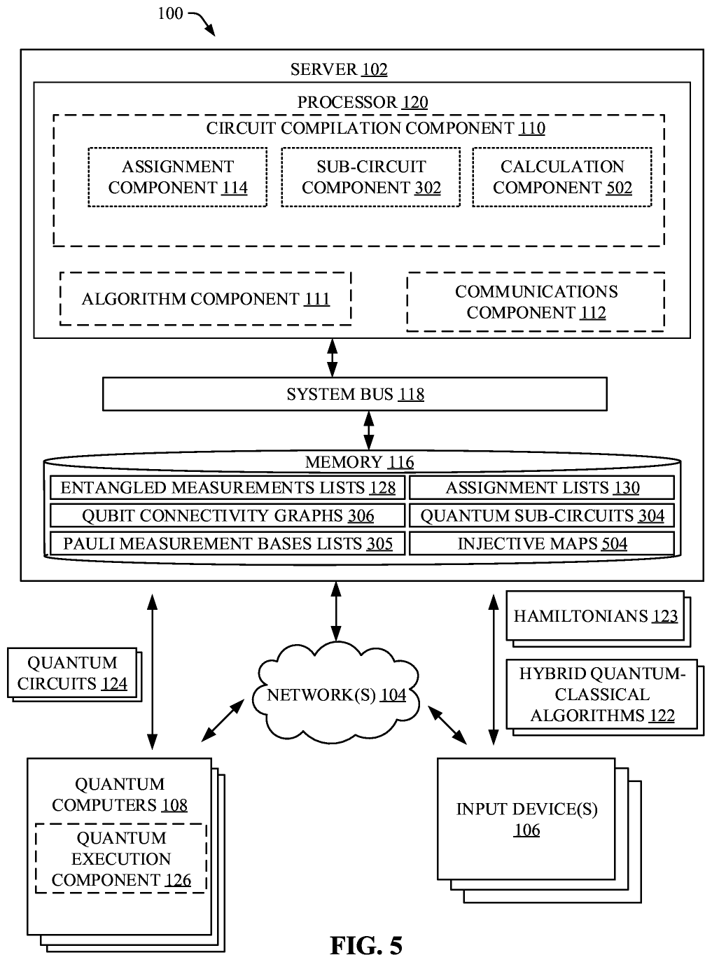

FIG. 5 illustrates a diagram of the example, non-limiting circuit compilation component 110 further comprising calculation component 502 in accordance with one or more embodiments described herein. Repetitive description of like elements employed in other embodiments described herein is omitted for the sake of brevity. In various embodiments, the calculation component 502 can generate a quantum circuit 124 for each of the Pauli string groups generated by the assignment component 114. Further, the generated quantum circuit 124 can include one or more mid-circuit operations to enable the assigned entangled measurements based on the measurement basis and/or qubit connectivity of the one or more quantum computers 108.

In various embodiments, the calculation component 502 can take as inputs: the one or more Pauli measurement bases lists 305, the one or more qubit connectivity graphs 306, and/or one or more injective maps 504. The one or more injective maps 504 can describe one or more relationships between logical qubits (e.g., of the one or more hybrid quantum-classical algorithms 122) and physical qubits (e.g., of the one or more quantum computers 108). For example, physical qubits can be represented as vertices in the one or more injective maps 504. In one or more embodiments, the one or more injective maps 504 can describe which physical qubits the one or more logical qubits correspond to in accordance with the one or more hybrid quantum-classical algorithms 122. In various embodiments, the one or more injective maps 504 can be comprised with the one or more hybrid quantum-classical algorithms 122 and/or can be entered separately into the system 100 via the one or more input devices 106.

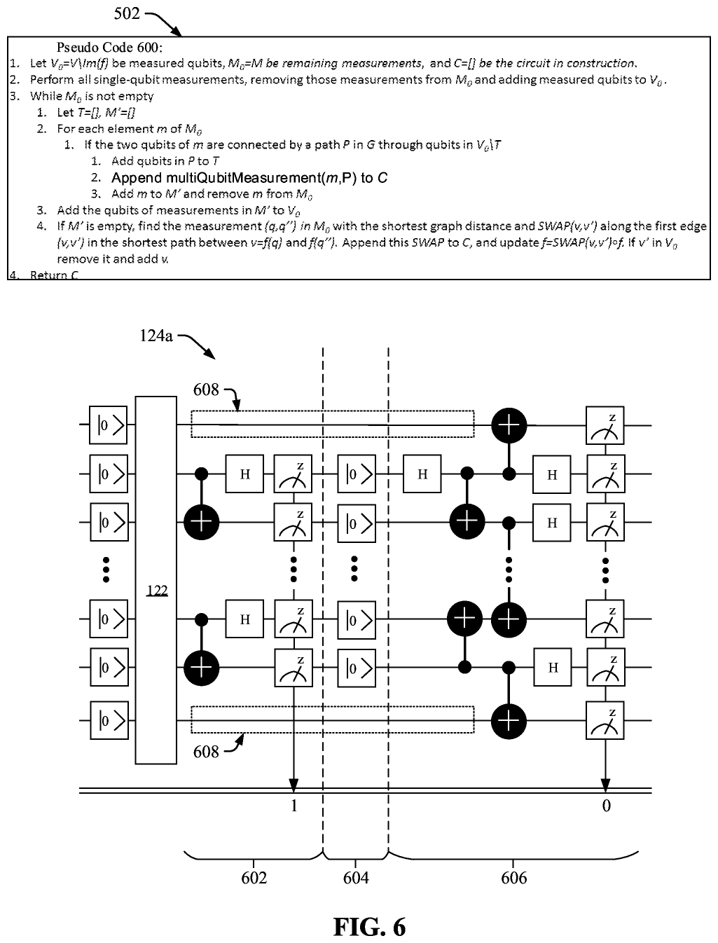

FIG. 6 illustrates a diagram of an example, non-limiting pseudo code 600 and/or a first example quantum circuit 124a that can be generated by the calculation component 502 in accordance with one or more embodiments described herein. Repetitive description of like elements employed in other embodiments described herein is omitted for the sake of brevity. In pseudo code 600: “f” can be the one or more injective maps 504; “G” can be the one or more qubit connectivity graphs 306, “V” can be vertices representing physical qubits in the one or more qubit connectivity graphs 306, “M” can be one or more tasked measurements, “m” can be a given measurement basis from the one or more Pauli measurement bases lists 305, “C” can be the quantum circuit 124 being generated by the calculation component 502, “q” can be a first physical qubit with corresponding first vertex “v” of the qubit connectivity graph 306, “q” “can be a second physical qubit with corresponding second vertex “v′” of the qubit connectivity graph 306, “T”” can contain a list of qubits on a path between “q” and “q”, “M′” can be a list of measurements from M₀ that are completed in an iteration of the loop, and “multiQubitMeasurement(m,P)” can be one or more algorithms executed by the sub-circuit component 302 to generate the one or more quantum sub-circuits 304 in accordance with the various embodiments described herein.

As shown in FIG. 6, the calculation component 502 can begin generating a portion of the quantum circuit 124 associated with single-qubit measurements; thereafter, removing the addressed single-qubit measurements from the applicable Pauli measurement bases list 305. Once the single-qubit measurements are complete, the measured qubits can serve as ancilla qubits for the remaining qubits to facilitate one or more subsequent entangled measurements (e.g., qubit states can be teleported through the ancilla qubits to enable a multi-qubit Pauli measurement). For instance, one or more target paths P from the one or more qubit connectivity graphs 306 (e.g., represented as G in pseudo code 600) can describe quantum state teleportation between ancilla qubits, such as previously measured qubits). Subsequently, the calculation component 502 can generate portions of the quantum circuit 124 regarding the multi-qubit measurements via entangled measurements, starting with entangled measurements involving nearest-neighboring qubits and progressing to entangled measurements that can utilize one or more quantum operations, such as SWAP gates and/or teleportation to move the measurement along a target path of qubit connectivity graph 306 associated with the qubit pairing of the entangled measurement.

For instance, the first example quantum circuit 124a can be generated by the calculation component 502 in accordance with the pseudo code 600 and the various embodiments described herein for one or more quantum computers 108 having a two-qubit measurement basis. As shown in FIG. 6, the hybrid quantum-classical algorithm 122 can be incorporated into the quantum circuit 124 (e.g., first example quantum circuit 124a) as, for example, a copy of one or more ansatz wavefunctions of the one or more hybrid quantum-classical algorithms 122. Further, portion 602 of the first example quantum circuit 124a can comprise mid-circuit entangled measurements for nearest-neighbor qubits. Subsequently, portion 604 of the first example quantum circuit 124a can comprise mid-circuit measurement reset operations. Moreover, portion 606 of the first example quantum circuit 124a can comprise entangled measurements enabled by one or more teleportation operations and/or SWAP gates. For example, portions 602, 604, and/or 606 can comprise a compilation of one or more quantum sub-circuits 304 generated by the sub-circuit component 302 (e.g., such as the first example quantum sub-circuit 304a, the second example quantum sub-circuit 304b, and/or the third example quantum sub-circuit 304c). Also, shown in the first example quantum circuit 124a, one or more echo sequences can be idled in one or more idling portions 608 in conjunction with the mid-circuit measurements of portion 602 and/or mid-circuit measurement reset operations of portion 604. Additionally, in one or more embodiments, the time synchronization of the one or more quantum circuits 124 can be less restrictive than the time synchronization depicted in the first example quantum circuit 124a. For example, with regards to the first example quantum circuit 124a, the measurements comprised within portion 602 can be done simultaneously or consecutively in time.

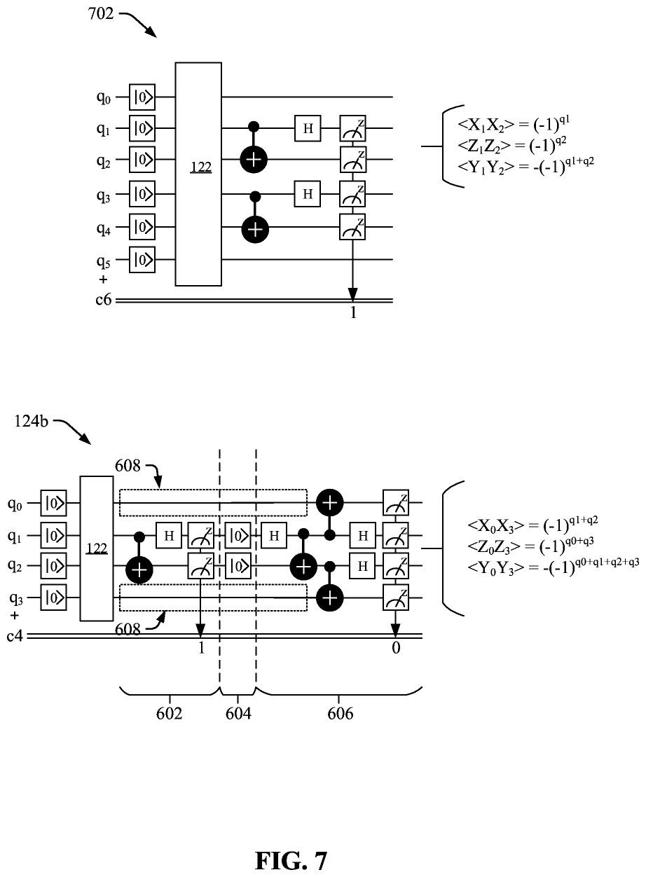

FIG. 7 illustrates a diagram of an example, non-limiting second example quantum circuit 124b that can be generated by the circuit compilation component 110 along with a comparative circuit 702 in accordance with one or more embodiments described herein. Repetitive description of like elements employed in other embodiments described herein is omitted for the sake of brevity. The second example quantum circuit 124b and the comparative circuit 702 can regard executing a VQE algorithm to find the energy of a lithium hydride molecule using one or more quantum computers 108 comprising 4 qubits and having a two-qubit measurement basis. The associate Hamiltonian 123 can comprise one hundred Pauli strings. Executing the VQE algorithm using just tensor product basis (“TPB”) Pauli string grouping can result in 25 circuits (e.g., calls) to the one or more quantum computers 108. Comparative circuit 702 utilizes just nearest neighbor Bell state measurements to reduce the calls to 17; however, the comparative circuit 702 can neglect to account for qubit topology of a designated quantum computer 108. The second example quantum circuit 124b can utilize TPB grouping of Pauli strings along with Bell state measurements and teleported Bell state measurements based on qubit topology of a quantum computer 108 to reduce the calls to 16 in accordance with various embodiments described herein. For instance, second example quantum circuit 124b can comprise one or more teleported Bell state measurements in portion 606 following a mid-circuit measurement in 602 and a mid-circuit measurement reset in 604 (e.g., as shown in FIG. 7).

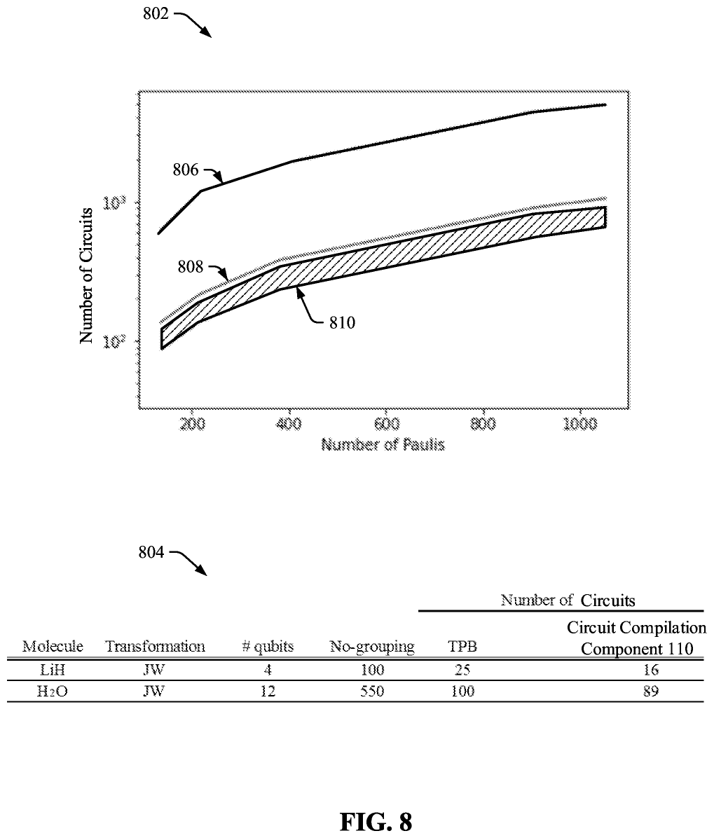

FIG. 8 illustrates a diagram of an example, non-limiting graph 802 and table 804 that can demonstrate how the call reduction achievable by the circuit compilation component 110 can scale with the size of the Hamiltonian 123 and/or the complexity of the one or more hybrid quantum-classical algorithm 122 in accordance with the various embodiments described herein. Repetitive description of like elements employed in other embodiments described herein is omitted for the sake of brevity. In graph 802, line 806 can represent executing a VQE algorithm on a quantum computer 108 with limited qubit connectivity without utilizing any circuit optimization techniques. Line 808 can represent executing the VQE algorithm on the quantum computer 108 utilizing TPB to group Pauli strings and reduce calls to the quantum computer 108. Line 810 can represent executing the VQE algorithm on the quantum computer 108 utilizing the circuit compilation component 110 to generate quantum circuits 124 comprising mid-circuit measurements and/or measurement reset operations to enable parallelized entangled measurements, such as TPB grouping along with Bell state measurements based on qubit topology of the quantum computer 108. As shown in graph 802, the circuit compilation component 110 can achieve an 11-36% reduction in the number of circuits (e.g., quantum circuits 124) over the comparative TPB approach.

Table 804 depicts the number of calls (e. quantum circuits) utilized during execution of a VQE algorithm to analyze a lithium hydride molecule and a water molecule on quantum computers 108 comprising 4 qubits and 12 qubits. Absent any Pauli string grouping and/or entangled measurements, analyzing the lithium hydride molecule comprises 100 calls to the quantum computer 108. Employing TPB can reduce the calls to 25, and employing TPB along with Bell state measurements via the circuit compilation component 110 (e.g., enabled through mid-circuit measurement operations and/or mid-circuit measurement reset operations) can further reduce the calls to 16 while accounting for the qubit topology of the quantum computer 108. Absent any Pauli string grouping and/or entangled measurements, analyzing the water molecule comprises 550 calls to the quantum computer 108. Employing TPB can reduce the calls to 100, and employing TPB along with Bell state measurements via the circuit compilation component 110 (e.g., enabled through mid-circuit measurement operations and/or mid-circuit measurement reset operations) can further reduce the calls to 89 while accounting for the qubit topology of the quantum computer 108.

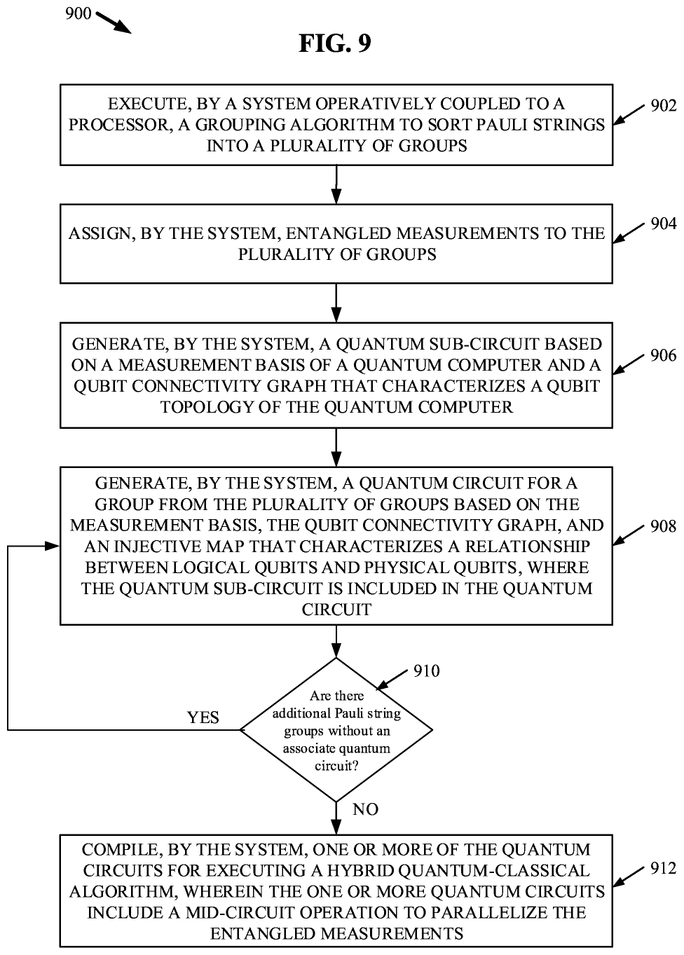

FIG. 9 illustrates a flow diagram of an example, non-limiting computer-implemented method 900 that can facilitate compiling one or more quantum circuits 124 that can parallelize entangled measurements based on qubit topology of one or more quantum computers 108 in accordance with one or more embodiments described herein. Repetitive description of like elements employed in other embodiments described herein is omitted for the sake of brevity.

At 902, the computer-implemented method 900 can comprise executing (e.g., via assignment component 114), by the system 100 operatively coupled to the processor 120, a grouping algorithm sort Pauli strings into a plurality of groups. Also, the computer-implemented method 900 can comprise assigning (e.g., via assignment component 114), by the system 100, entangled measurements to the plurality of groups. For example, the Pauli strings can be defined by one or more Hamiltonians 123 to be analyzed by one or more hybrid quantum-classical algorithms 122.

At 906, the computer-implemented method 900 can comprise generating (e.g., via sub-circuit component 302), by the system 100, one or more quantum sub-circuits 304 based on a measurement basis of one or more quantum computers 108 and one or more qubit connectivity graphs 306 that can characterize a qubit topology of the quantum computer 108. In various embodiments, the measurement basis can be defined by one or more Pauli measurement bases lists 305. For example, the first example quantum sub-circuit 302a, the second example quantum sub-circuit 302b, and/or the third example quantum sub-circuit 302c can be generated at 906. At 908, the computer-implemented method 900 can comprise generating (e.g., via calculation component 502), by the system 100, a quantum circuit 124 for a group from the plurality of groups generated at 902 based on the measurement basis, the qubit connectivity graph 306, and/or one or more injective maps 504 that can characterize relationships between logical qubits and physical qubits. Further, the one or more quantum sub-circuits 304 generated at 906 can be included in the quantum circuit 124 generated at 908.

At 910, the computer-implemented method 900 can determine (e.g., via circuit compilation component 110), by the system 100, whether there are additional Pauli string groups generated at 902 and without an associate quantum circuit 124. Where there are additional Pauli string groups without an associate quantum circuit 124, the computer-implemented method 900 can repeat step 908 and generate an additional quantum circuit 124 for one of the additional Pauli string groups. Where there are no additional Pauli string groups without an associate quantum circuit 124, the computer-implemented method 900 can proceed to 912. At 912, the computer-implemented method 900 can compile (e.g., via circuit compilation component 110), by the system 100, one or more of the quantum circuits 124 for executing one or more hybrid quantum-classical algorithms 122, where the one or more quantum circuits 124 can include one or more mid-circuit operations (e.g., mid-circuit measurement operations and/or mid-circuit measurement reset operations) to parallelize the entangled measurements.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

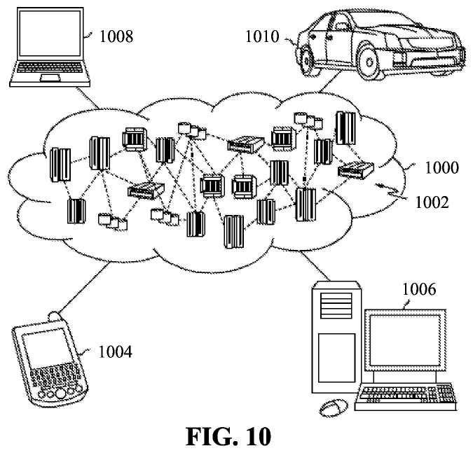

Referring now to FIG. 10, illustrative cloud computing environment 1000 is depicted. As shown, cloud computing environment 1000 includes one or more cloud computing nodes 1002 with which local computing devices used by cloud consumers, such as, for example, personal digital assistant (PDA) or cellular telephone 1004, desktop computer 1006, laptop computer 1008, and/or automobile computer system 1010 may communicate. Nodes 1002 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1004-1010 shown in FIG. 10 are intended to be illustrative only and that computing nodes 1002 and cloud computing environment 1000 can communicate with any type of computerized device over any type of network and/or network addressable connection (e.g., using a web browser).

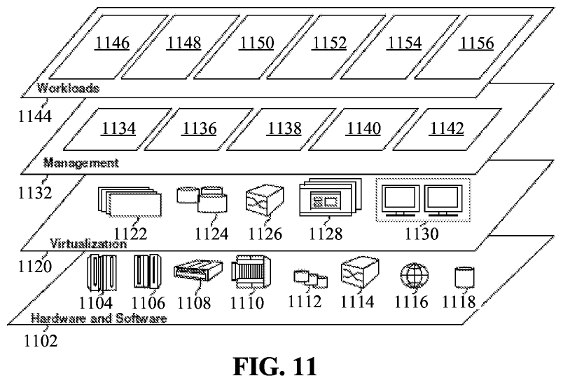

Referring now to FIG. 11, a set of functional abstraction layers provided by cloud computing environment 1000 (FIG. 10) is shown. Repetitive description of like elements employed in other embodiments described herein is omitted for the sake of brevity. It should be understood in advance that the components, layers, and functions shown in FIG. 11 are intended to be illustrative only and embodiments of the invention are not limited thereto. As depicted, the following layers and corresponding functions are provided.

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and quantum circuit 124 generation 1156. Various embodiments of the present invention can utilize the cloud computing environment described with reference to FIGS. 10 and 11 to compile quantum circuits 124 for executing one or more hybrid quantum-classical algorithms 122, where the quantum circuits can include mid-circuit operations and parallelized entangled measurements.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

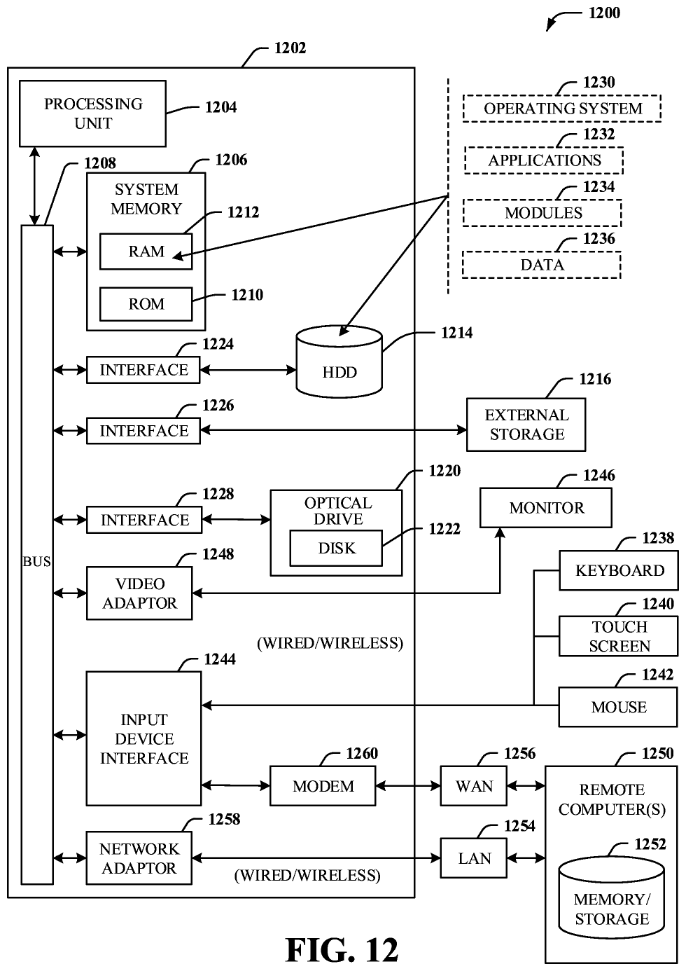

In order to provide additional context for various embodiments described herein, FIG. 12 and the following discussion are intended to provide a general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, and/or the like, that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (“IoT”) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices. For example, in one or more embodiments, computer executable components can be executed from memory that can include or be comprised of one or more distributed memory units. As used herein, the term “memory” and “memory unit” are interchangeable. Further, one or more embodiments described herein can execute code of the computer executable components in a distributed manner, e.g., multiple processors combining or working cooperatively to execute code from one or more distributed memory units. As used herein, the term “memory” can encompass a single memory or memory unit at one location or multiple memories or memory units at one or more locations.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (“RAM”), read only memory (“ROM”), electrically erasable programmable read only memory (“EEPROM”), flash memory or other memory technology, compact disk read only memory (“CD-ROM”), digital versatile disk (“DVD”), Blu-ray disc (“BD”) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (“BIOS”) can be stored in a non-volatile memory such as ROM, erasable programmable read only memory (“EPROM”), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (“HDD”) 1214 (e.g., EIDE, SATA), one or more external storage devices 1216 (e.g., a magnetic floppy disk drive (“FDD”) 1216, a memory stick or flash drive reader, a memory card reader, a combination thereof, and/or the like) and an optical disk drive 1220 (e.g., which can read or write from a CD-ROM disc, a DVD, a BD, and/or the like). While the internal HDD 1214 is illustrated as located within the computer 1202, the internal HDD 1214 can also be configured for external use in a suitable chassis (not shown). Additionally, while not shown in environment 1200, a solid state drive (“SSD”) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (“USB”) and Institute of Electrical and Electronics Engineers (“IEEE”) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (“VM”) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (“TPM”). For instance with a TPM, boot components hash next in time boot components, and wait for a match of results to secured values, before loading a next boot component. This process can take place at any layer in the code execution stack of computer 1202, e.g., applied at the application execution level or at the operating system (“OS”) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (“IR”) remote control, a radio frequency (“RF”) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, and/or the like.

A monitor 1246 or other type of display device can be also connected to the system bus 1208 via an interface, such as a video adapter 1248. In addition to the monitor 1246, a computer typically includes other peripheral output devices (not shown), such as speakers, printers, a combination thereof, and/or the like.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (“LAN”) 1254 and/or larger networks, e.g., a wide area network (“WAN”) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (“AP”) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, and/or the like), and telephone. This can include Wireless Fidelity (“Wi-Fi”) and BLUETOOTH® wireless technologies. Thus, the communication can be a predefined structure as with a conventional network or simply an ad hoc communication between at least two devices.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor, operably coupled to the memory, and that executes the computer executable components stored in the memory, wherein the computer executable components comprise:
a circuit compilation component that compiles one or more quantum circuits for a hybrid quantum-classical algorithm, wherein the one or more quantum circuits include a mid-circuit operation to parallelize entangled measurements.

2. The system of claim 1, wherein the mid-circuit operation is at least one operation selected from the group consisting of a mid-circuit measurement and a mid-circuit measurement reset.

3. The system of claim 1, further comprising:
an assignment component that executes a grouping algorithm to sort Pauli strings into a plurality of groups and assign the entangled measurements to the plurality of groups.

4. The system of claim 3, wherein the entangled measurements comprise at least one member selected from the group consisting of a Bell basis entangled measurement and an omega basis entangled measurement.

5. The system of claim 3, further comprising:
a sub-circuit component that generates a quantum sub-circuit based on a measurement basis of a quantum computer executing the hybrid quantum-classical algorithm and a qubit connectivity graph that characterizes a qubit topology of the quantum computer.

6. The system of claim 5, further comprising:
a calculation component that generates a quantum circuit of the one or more quantum circuits for a group from the plurality of groups based on the measurement basis, the qubit connectivity graph, and an injective map that characterizes a relationship between logical qubits and physical qubits, wherein the quantum sub-circuit is included in the quantum circuit.

7. A computer-implemented method, comprising:
compiling, by a system operatively coupled to a processor, one or more quantum circuits for a hybrid quantum-classical algorithm, wherein the one or more quantum circuits include a mid-circuit operation to parallelize entangled measurements.

8. The computer-implemented method of claim 7, wherein the mid-circuit operation is at least one operation selected from the group consisting of a mid-circuit measurement and a mid-circuit measurement reset.

9. The computer-implemented method of claim 7, further comprising:
executing, by the system, a grouping algorithm to sort Pauli strings into a plurality of groups; and
assigning, by the system, the entangled measurements to the plurality of groups.

10. The computer-implemented method of claim 9, further comprising:
generating, by the system, a quantum sub-circuit based on a measurement basis of a quantum computer executing the hybrid quantum-classical algorithm and a qubit connectivity graph that characterizes a qubit topology of the quantum computer; and
generating, by the system, a quantum circuit of the one or more quantum circuits for a group from the plurality of groups based on the measurement basis, the qubit connectivity graph, and an injective map that characterizes a relationship between logical qubits and physical qubits, wherein the quantum sub-circuit is included in the quantum circuit.

11. A system, comprising:
a memory that stores computer executable components; and
a processor, operably coupled to the memory, and that executes the computer executable components stored in the memory, wherein the computer executable components comprise:
a circuit compilation component that compiles one or more quantum circuits that include a mid-circuit operation and parallelized entangled measurements based on qubit topology of a quantum computer.

12. The system of claim 11, wherein the one or more quantum circuits are compiled to implement a hybrid quantum-classical algorithm, and wherein the mid-circuit operation is at least one operation selected from the group consisting of a mid-circuit measurement and a mid-circuit measurement reset.

13. The system of claim 11, further comprising:
an assignment component that executes a grouping algorithm to sort Pauli strings into a plurality of groups and assign the entangled measurements to the plurality of groups.

14. The system of claim 13, further comprising:
a sub-circuit component that generates a quantum sub-circuit based on a measurement basis of the quantum computer and a qubit connectivity graph that characterizes the qubit topology.

15. The system of claim 14, further comprising:
a calculation component that generates a quantum circuit of the one or more quantum circuits for a group from the plurality of groups based on the measurement basis, the qubit connectivity graph, and an injective map that characterizes a relationship between logical qubits and physical qubits, wherein the quantum sub-circuit is included in the quantum circuit.

16. A computer-implemented method, comprising:
compiling, by a system operatively coupled to a processor, one or more quantum circuits that include a mid-circuit operation and parallelized entangled measurements based on qubit topology of a quantum computer.

17. The computer-implemented method of claim 16, wherein the one or more quantum circuits are compiled to implement a hybrid quantum-classical algorithm, and wherein the mid-circuit operation is at least one operation selected from the group consisting of a mid-circuit measurement and a mid-circuit measurement reset.

18. The computer-implemented method of claim 16, further comprising:
executing, by the system, a grouping algorithm to sort Pauli strings into a plurality of groups; and
assigning, by the system, the entangled measurements to the plurality of groups.

19. The computer-implemented method of claim 18, further comprising:
generating, by the system, a quantum sub-circuit based on a measurement basis of the quantum computer and a qubit connectivity graph that characterizes the qubit topology.

20. The computer-implemented method of claim 19, further comprising:
a calculation component that generates a quantum circuit of the one or more quantum circuits for a group from the plurality of groups based on the measurement basis, the qubit connectivity graph, and an injective map that characterizes a relationship between logical qubits and physical qubits, wherein the quantum sub-circuit is included in the quantum circuit.

21. A computer program product for compiling quantum circuits, the computer program product comprising a computer readable storage medium having program instructions embodied therewith, the program instructions executable by a processor to cause the processor to:
compile one or more quantum circuits for a hybrid quantum-classical algorithm, wherein the one or more quantum circuits include a mid-circuit operation to parallelize entangled measurements.

22. The computer program product of claim 21, wherein the mid-circuit operation is at least one operation selected from the group consisting of a mid-circuit measurement and a mid-circuit measurement reset.

23. The computer program product of claim 21, wherein the program instructions further cause the processor to:
execute a grouping algorithm to sort Pauli strings into a plurality of groups; and
assign the entangled measurements to the plurality of groups.

24. The computer program product of claim 23, wherein the program instructions further cause the processor to:
generate a quantum sub-circuit based on a measurement basis of a quantum computer executing the hybrid quantum-classical algorithm and a qubit connectivity graph that characterizes a qubit topology of the quantum computer.

25. The computer program product of claim 24, wherein the program instructions further cause the processor to:
generate a quantum circuit of the one or more quantum circuits for a group from the plurality of groups based on the measurement basis, the qubit connectivity graph, and an injective map that characterizes a relationship between logical qubits and physical qubits, wherein the quantum sub-circuit is included in the quantum circuit.
